(19) United States
(12) Patent Application Publication
(10) Pub. No.: US 2025/0170764 A1
(43) Pub. Date: May 29, 2025

(54) PASS-THROUGH BACK INJECTION COMPOSITE MATS AND MAT FEATURES

(71) Applicant: Tesla, Inc., Austin, TX (US)

(72) Inventors: Karun Balachandran, Hayward, CA (US); Sepehr Rostamzadeh, Palo Alto, CA (US); Shakeel Theodore, Fremont, CA (US); Alessandro Bernardis, Fremont, CA (US)

(21) Appl. No.: 18/946,358

(22) Filed: Nov. 13, 2024

Related U.S. Application Data
(60) Provisional application No. 63/603,222, filed on Nov. 28, 2023.

(51) Int. Cl. B29C 45/14; B29K 23/00; B29L 31/30; B32B 27/08; B32B 27/32

(52) U.S. Cl. CPC B29C 45/14344; B29C 2045/14967; B29K 2023/12; B29L 2031/3041

(57) ABSTRACT

In some disclosed examples, a structure can include a panel having a first side and a second side and can comprise a permeable matrix. The structure can also include a feature coupled to the panel by being injection molded from the second side and passing through the permeable matrix to the first side.

### CLAIM OF PRIORITY

This patent application claims the benefit of priority, under 35 U.S.C. Section 119(e), to Balachandran, U.S. Provisional Patent Application Ser. No. 63/603,222, entitled “PASS-THROUGH BACK INJECTION COMPOSITE MATS AND MAT FEATURES,” filed on Nov. 28, 2023 (Attorney Docket No. 6474.037PRV), which is hereby incorporated by reference herein in its entirety.

### BACKGROUND

Many structures are formed by compression molding techniques, wherein fiber materials and/or other materials are compression molded into a part. For example, vehicle interior trim panels are often formed by compression molding. In some cases, vehicle trim panels are configured to house or interface with other vehicle components, such as air bags, speakers, control panels, etc. The interface is often achieved by cutting the trim panel to accept the other component and welding the component to the trim panel. Some types of interfacing can be achieved by cutting the trim panel to expose an open space for the other component, forming the other component by injection molding within the open space, and possibly welding the component to the trim panel. Additionally, when the vehicle interior requires a complex surface or large opening, such as for a map pocket or other storage space, it is often necessary to use multiple compression-molded pieces and to make multiple cuts in at least some of the pieces.

### SUMMARY

Examples described herein may provide a structure comprising a panel having a first side and a second side and comprising a permeable matrix. At least one feature may be coupled to the panel by being injection molded from the second side and passing through the permeable matrix to the first side. In some examples, the panel may further comprise at least one first section having a first thickness and at least one second section formed integrally with the at least one first section and having a second thickness that is thinner than the first thickness. The at least one second section may form at least one living hinge within the panel. In some examples, the panel may be installed within an assembly with the at least one living hinge in a folded position. In some examples, the at least one first section and the at least one second section may be respective sections of a contiguously-formed molded matrix. In some examples, the at least one feature may pass through the permeable matrix at an uncut location within the permeable matrix. In some examples, the permeable matrix may comprise an injection-molded composite material and/or the at least one feature may comprise a thermoplastic material.

Examples described herein may provide a structure comprising a single-piece molded matrix. The single-piece molded matrix may comprise at least one first section having a first thickness and at least one second section formed integrally with the at least one first section and having a second thickness that is thinner than the first thickness. The at least one second section may form at least one living hinge within the single-piece molded matrix. In some examples, the at least one first section may be permeable and may have a first side and a second side. The structure may further comprise at least one feature coupled to the at least one first section by being injection molded from the second side and passing through to the first side. In some examples, the at least one second section may be defined by a shape of a mold in which the single-piece molded matrix is formed. In some examples, the single-piece molded matrix may be installed within an assembly with the at least one living hinge in a folded position. In some examples, the single-piece molded matrix may comprise an injection-molded composite material.

Examples described herein may provide a method comprising loading a panel having a first side and a second side and comprising a permeable matrix into an injection tool; providing a mold facing the first side of the panel, the mold defining at least one feature to be formed by material injected into the mold; injecting, by the injection tool, the material through the permeable matrix so that the material passes through the permeable matrix from the second side to the first side by the injecting; and setting the material that has been injected through the permeable matrix within the mold to form the at least one feature and couple the at least one feature to the panel. In some examples, the injecting may force the material through an uncut portion of the permeable matrix through injection pressure. Some examples of the method may further comprise heating the material prior to the injecting, wherein the setting comprises cooling the material within the mold. Some examples of the method may further comprise trimming at least one of the at least one feature and the permeable matrix after the setting. Some examples of the method may further comprise forming the panel. Forming the panel may comprise filling a mold with a composite material, wherein the mold defines a shape of the panel such that at least one first section of the panel has a first thickness, and at least one second section formed integrally with the at least one first section has a second thickness that is thinner than the first thickness, the at least one second section forming at least one living hinge within the panel; and setting the composite material in the mold to form the panel. Some examples of the method may further comprise installing the panel into an assembly after the setting, and the installing may comprise folding the at least one living hinge and securing the panel to the assembly with the at least one living hinge in a folded position. In some examples, the permeable matrix may comprise an injection-molded composite material, and/or the material may comprise a thermoplastic material.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1A shows a first side (A side) of a structure including a panel and a feature according to some examples of the present disclosure.

FIG. 1B shows a second side (B side) of a structure including a panel and a feature according to some examples of the present disclosure.

FIG. 2A shows a cross-section of a panel loaded into a tool according to some examples of the present disclosure.

FIG. 2B shows a cross-section of a panel with a feature being formed in a tool according to some examples of the present disclosure.

FIG. 3A shows an A side of a panel with a living hinge according to some examples of the present disclosure.

FIG. 3B shows a B side of a panel with a living hinge according to some examples of the present disclosure.

FIG. 4A shows a cross-section of a panel with a living hinge according to some examples of the present disclosure.

FIG. 4B shows a cross-section of a panel with a folded living hinge according to some examples of the present disclosure.

FIG. 4C shows a cross-section of a panel with a living hinge being formed in a tool according to some examples of the present disclosure.

FIG. 5 shows a method of manufacturing a panel with a feature according to some examples of the present disclosure.

FIG. 6 shows a method of manufacturing a panel with a living hinge according to some examples of the present disclosure.

The drawings are not necessarily to scale, or inclusive of all elements of a system, emphasis instead generally being placed upon illustrating the concepts, structures, and techniques sought to be protected herein.

### DETAILED DESCRIPTION OF EXAMPLES

The following examples disclosed in the detailed description are merely examples and are not intended to limit the claimed invention or the applications of its use.

Examples described herein can provide panels or other structures, such as vehicle interior panels, including plastic features back injected thereon. A permeable matrix, such as a composite compression-molded mat or the like, can serve as a panel body. A thermoplastic or other injectable material can be back injected from a B side of the panel through the permeable matrix to the A side of the panel, where the material can form a feature (e.g., bracket, handle, sub-panel, etc.) once set.

Examples of panels or other structures described herein may include living hinges formed therein, allowing a single-piece panel to have a complex, folded geometry without cutting or welding of multiple pieces. A single-piece molded matrix, such as a composite compression-molded mat or the like, may be formed to have areas of differing thickness, with a thinner portion being formed thin enough to be bendable once the matrix is finished. The thin, bendable portion can form a living hinge within the finished panel, allowing the panel to be bent and installed in a desired location, thereby forming structures such as map pockets or the like, and/or conforming to non-planar installation geometries.

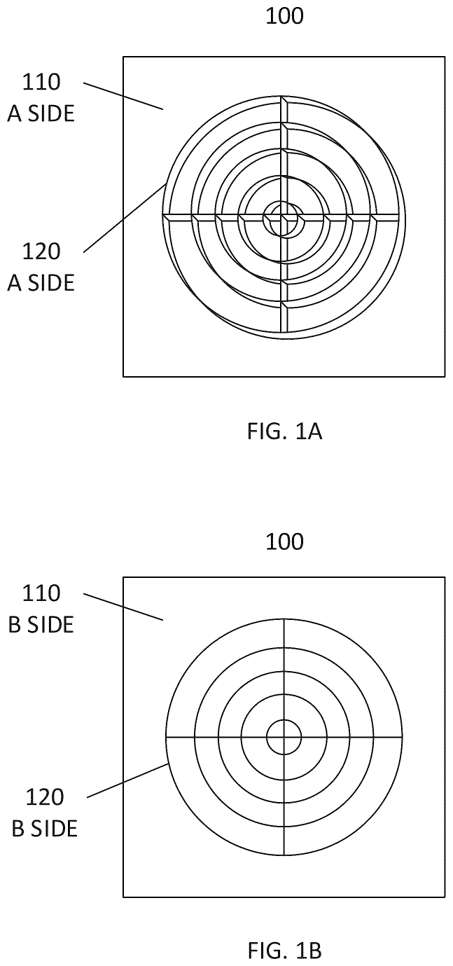

FIG. 1A shows a first side (A side), and FIG. 1B shows a second side (B side), of a structure 100 including a panel 110 and a feature 120 according to some examples of the present disclosure. As described in detail below, structure 100 can be formed by injection molding material on the B side of panel 110. Due to a permeability of panel 110 and a pressure of injection, the material can pass through panel 110 to the A side, where it can form feature 120. Accordingly, feature 120 can be formed and affixed to panel 110 without cutting panel 110 at the site of feature 120. This can reduce processing steps and reduce material waste compared with processes involving panel pre-cutting and injection molding and/or compared with processes involving forming features separately and bonding them to panels.

Panel 110 can include a first side (A side—FIG. 1A) and a second side (B side—FIG. 1B). Panel 110 may include and/or may be entirely comprised of a permeable matrix. For example, the permeable matrix may include an injection-molded composite material. Examples of injection-molded composite materials that may be used for panel 110 can include, but are not limited to, glass-filled polymer, glass fiber-reinforced polypropylene, natural fiber-reinforced polypropylene, and/or branded materials by made by Azdel and/or Mitsubishi Chemical Advanced Materials.

Feature 120 can be formed and attached to panel 110 by injection molding. As shown in FIG. 1A, a functional side of feature 120 can be disposed on the A side of panel 110. As shown, the A side of feature 120 is molded to a desired shape and size (e.g., is raised from the surface of panel 110 in the depicted example). The B side of feature 120 may be generally flat and/or not deliberately shaped, as the B side is the side from which feature 120 is injected into panel 110. Examples of features 120 can include, but are not limited to, ribs, attachment points, doghouses, locators, heat stake welding points, speaker grill patterns, and/or airbag chute structures.

As described in detail below, by injecting material from the B side directly through panel 110 into a mold disposed along the A side of panel 110, feature 120 may be both formed and coupled to panel 110. That is, at least one feature 120 may be coupled to panel 110 by being injection molded from the second side and passing through the permeable matrix to the first side. Feature 120 can pass through the permeable matrix of panel 110 at an uncut location within the permeable matrix. That is, no pre-cutting is necessary for the injected material to pass through the permeable matrix. Feature 120 may be made of a thermoplastic material or other suitable material that can be injection molded. Examples of materials used to make feature 120 may include, but are not limited to, polypropylene blends such as PP MD20, PP MD10, PP GF10, PP GF30, etc. Materials for feature 120 may be selected according to design choice for having properties such as desired permeability, desired density, desired tensile modulus, desired melting point, desired flow rate, desired shrink rate, desired thickness swelling rate, desired holding pressure, desired back pressure, desired feeding temperature, desired mold temperature, and/or desired mass temperature, for example.

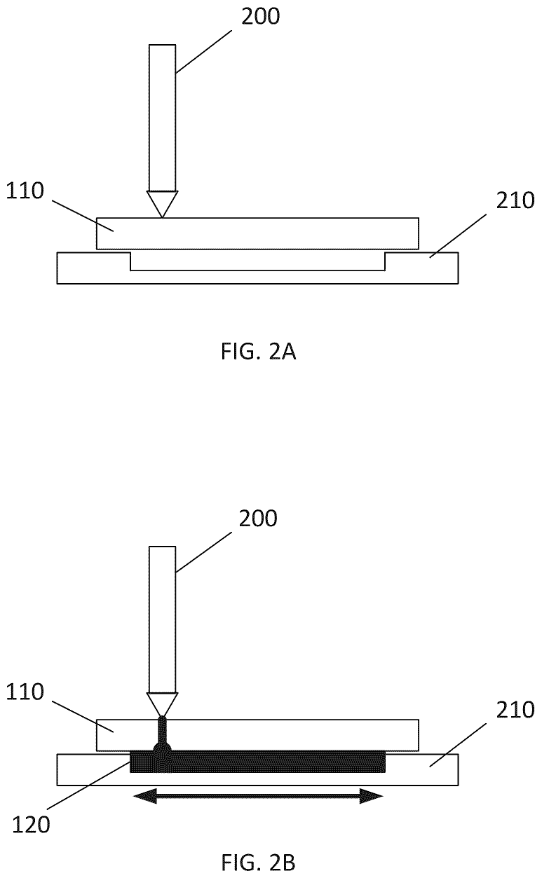

FIGS. 2A and 2B demonstrate how feature 120 can be formed and attached to panel 110 in some examples. FIG. 2A shows a cross-section of panel 110 loaded into a tool according to some examples of the present disclosure. Note that the tool is not depicted using a lifelike representation, but in the form of a functional diagram to highlight the physical arrangement of functional tool elements to panel 110 when panel 110 is loaded in the tool. In some examples, the tool used can be a hybrid compression and injection molding tool which can provide compression for panel 110 and back injection for feature 120. The tool can include injector 200 and mold 210. Panel 110 can be loaded into the tool with panel 110 A side facing mold 210 and panel 110 B side facing injector 200. Mold 210 can be configured according to the desired shape of feature 120. Here, mold 210 is shown in cross section, but it will be understood that mold 210 can have any three-dimensional shape. For example, mold 210 can be configured to produce feature 120 of FIGS. 1A and 1B, or any other feature 120.

FIG. 2B shows a cross-section of panel 110 with feature 120 being formed in the tool according to some examples of the present disclosure. As shown, injector 200 can inject material into panel 110 B side, and the material can flow through panel 110, out panel 110 A side, and into mold 210. Injection pressure can force the material through the permeable matrix of panel 110. A gate of injector 200, from which material flows, may be positioned close to panel 110 so that effective injection pressure can be attained. Features 120 have been successfully molded to panels 110 with pressures of 35 MPa, but it will be understood by those of ordinary skill that effective pressure may vary according to materials used for panel 110 and/or feature 120. For example, effective pressures may be identified based on the Calpeyron equation, AP/AT =AHvap/(TAV), where AP/AT is the rate of change of pressure with temperature, AHvap is the heat of vaporization, T is the absolute temperature in Kelvin, and AV is the change in volume during the phase transition.

Injector 200 can inject material at one or multiple points along panel 110 B side. The material can flow within mold 210, as shown by the arrow, to fill mold 210. The material can set (e.g., by cooling) to form feature 120 and bond feature 120 to panel 110. Accordingly, when panel 110 is removed from the tool, panel 110 may have feature 120 integrally formed thereon. Any excess material of feature 120 can be trimmed as desired. Likewise, any excess of the permeable matrix or other structure(s) of panel 110 can be trimmed as desired, although such cutting is not necessary for the formation of feature 120, which can be injected directly through the permeable matrix of panel 110.

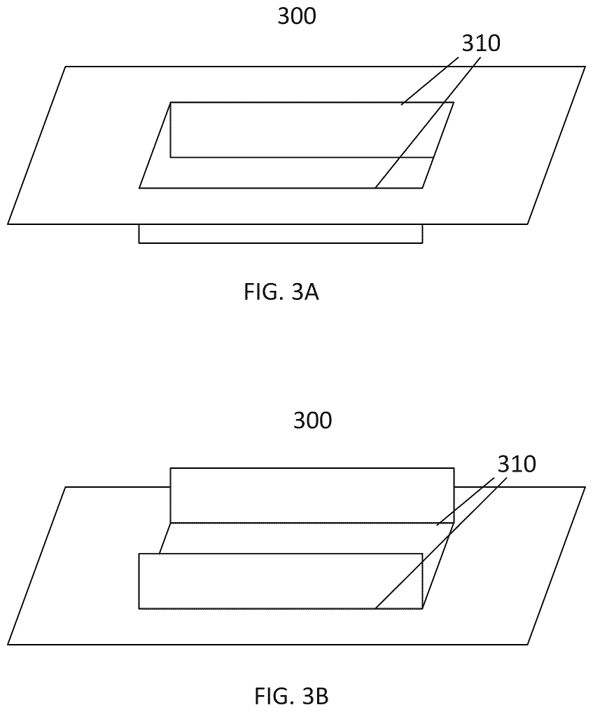

In addition, or alternatively, to the integration of feature 120 with panel 110 described above, some examples may have one or more living hinges formed in a panel. FIG. 3A shows an A side, and FIG. 3B shows a B side, of panel 300 with living hinges 310 according to some examples of the present disclosure. As described in detail below, living hinges 310 can be formed in panel 300 so that panel 300 can be bent into complex shapes without requiring multiple pieces of panel 300 to be cut and welded together. This can facilitate the installation of single-piece panels 300 with built-in recesses such as map pockets, for example (and/or built-in recesses or other shapes requiring fewer welds than for panels entirely lacking living hinges 310). While not shown, it will be understood that a panel can be formed to include both one or more features 120 and one or more living hinges 310 in some examples.

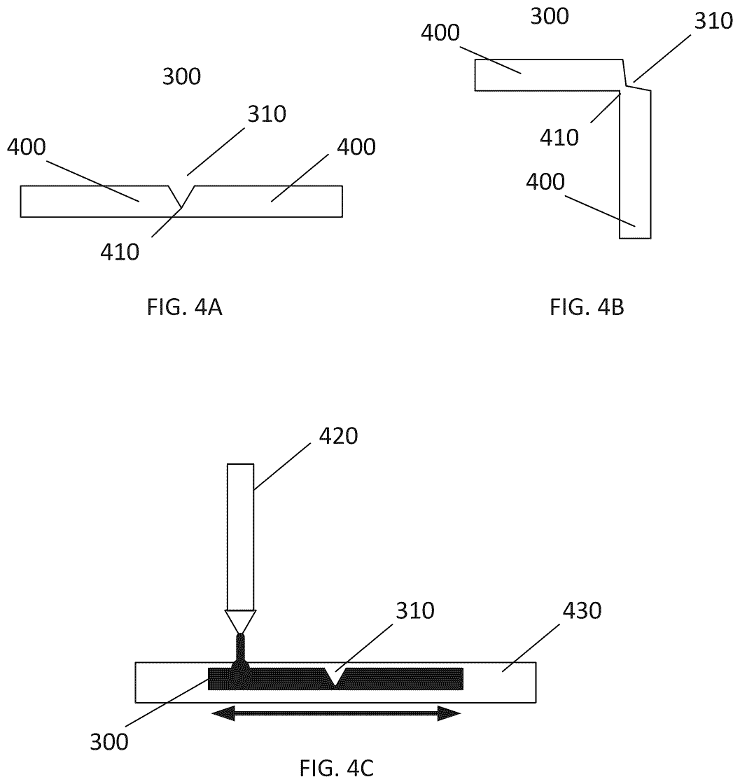

FIG. 4A shows a cross-section of panel 300 with living hinge 310 unfolded, and FIG. 4B shows a cross-section of panel 300 with living hinge 310 folded, according to some examples of the present disclosure. As can be seen in the cross-section, panel 300 can have at least one first section 400 (e.g., two or more first sections 400) having a first thickness and at least one second section 410 formed integrally with the first sections 400 and having a second thickness that is thinner than the first thickness. For example, in some examples first section 400 has a thickness in the range of 0.5-3.5 mm, and second section 410 has a thickness in the range of 0.3-1 mm. The at least one second section 410 can form at least one living hinge 310 within the panel 300. In the example of FIGS. 4A and 4B, a single second section 410 is disposed between two thicker first sections 400, and the second section 410 has a triangular cross section. It will be understood that some panels 300 may have more than one second section 410 and/or that the cross-section of the second section(s) can be a different shape, such as a square, rectangular, or arcuate shape, for example. As shown in FIG. 4B, panel 300 can be bent along the living hinge 310. Accordingly, panel 300 can be installed within an assembly (e.g., a door frame or other portion of a car interior) with the at least one living hinge 310 in a folded position.

FIG. 4C shows a cross-section of panel 300 with living hinge 310 being formed in a tool according to some examples of the present disclosure. Note that the tool is not depicted using a lifelike representation, but in the form of a functional diagram to highlight the physical arrangement of functional tool elements configured to form panel 300. Any compression tool available to those of ordinary skill in the art may be used. The tool can include injector 420 and mold 430. Mold 430 can be shaped to form hinge 310 in panel 300, as shown. That is, mold 430 can define the first sections 400 having the first thickness and the at least one second section 410 having the second thickness in negative space. Thus, when injector 420 injects material (e.g., an injection-molded composite material such as a polypropylene based composite mat selected for desirable strain to failure, modulus, and/or yield strength) into the negative space, panel 300 with thicker first section(s) 400 and thinner second section(s) 410 are formed. Panel 300 can set (e.g., by cooling) and be released from mold 430. The result can be a panel 300 wherein the at least one first section 400 and the at least one second section 410 are respective sections of a contiguously-formed, single-piece molded matrix.

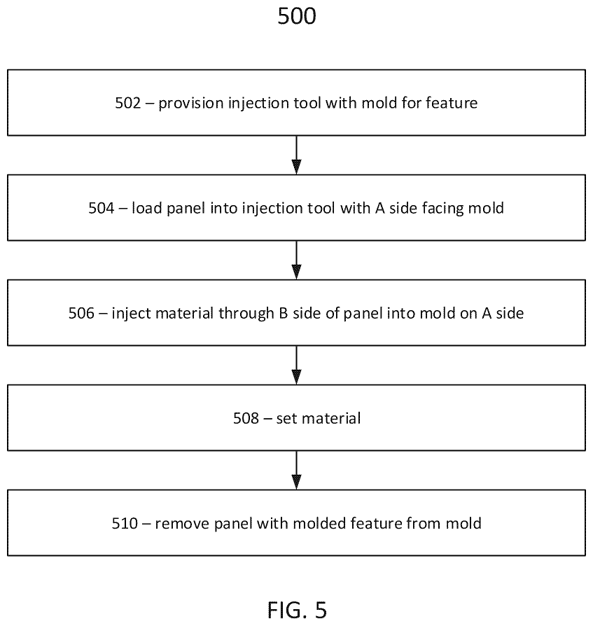

FIG. 5 shows a method 500 of manufacturing a panel with a feature according to some examples of the present disclosure. For example, method 500 may be used to manufacture a structure such as those shown in FIGS. 1A-1B. Method 500 may include processing operations such as those shown in FIGS. 2A-2B in some examples.

At 502, an injection tool can be provisioned for creating a panel with pass-through molded feature(s) as described above. For example, this can include installing a mold for the feature and/or adjusting any processing settings that may be required for the remaining portions of method 500 (e.g., distance from gate of injector 200 to surface of panel 110 to attain effective pressure, as noted above). The mold can be configured to define at least one feature to be formed by material injected into the mold.

At 504, a panel (e.g., panel 110) may be loaded into the injection tool with its A side facing the mold. As described above, the panel can have a first side (A side) and a second side (B side) and may comprise a permeable matrix.

At 506, the injection tool can be operated to inject material through the panel and into the mold. For example, as described above, the injector can be positioned in contact with or adjacent to the B side of the panel. The injector can inject material into the panel at the B side in one or more locations. In at least some examples, the injection tool may heat the material prior to the injecting (e.g., to allow it to flow). Due to injection pressure, the material can pass through the permeable matrix to the A side and into the mold. The material can pass through without any pre-cutting of the panel (e.g., the injecting may force the material through an uncut portion of the permeable matrix through injection pressure). As described above, the material can fill the mold.

As a non-limiting representative example, clamping pressures of 80-120 Bar, injection pressures of 20-25 Bar, injection cycle time of 80 seconds with cool time of 25 seconds, and temperatures of 190-240 C have been used as tooling parameters to create panels 110 with features 120 injected thereon, it will be appreciated that different materials being used, structures being produced, and equipment being used may call for different tooling parameters, and such different tooling parameters are understandable to those of ordinary skill in the art.

At 508, the material that has been injected through the permeable matrix within the mold can set to form the feature(s) defined by the mold and, at the same time, to couple the feature(s) to the panel. In at least some examples, the setting may comprise cooling the material within the mold.

At 510, the panel with the molded feature (e.g., feature 120) may be removed from the mold. In some examples, at least one of the at least one feature and the permeable matrix may be trimmed after the material within the mold has set, either before or after removal from the mold.

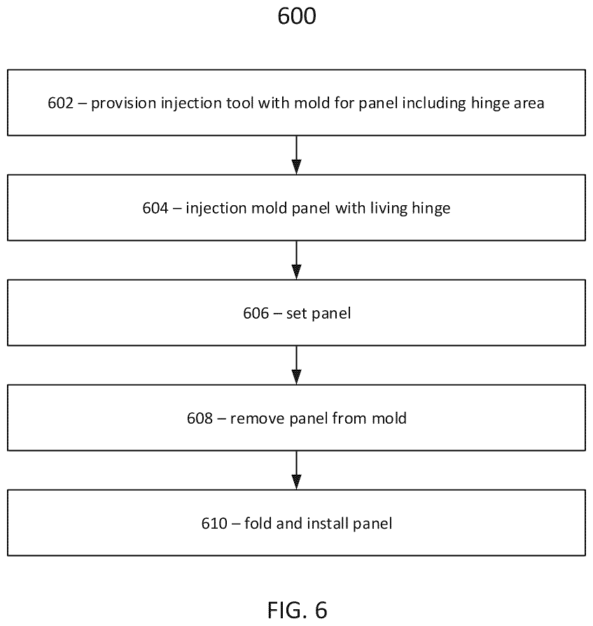

FIG. 6 shows a method 600 of manufacturing a panel with a living hinge according to some examples of the present disclosure. For example, method 600 may be used to manufacture a structure such as those shown in FIGS. 3A-4B. Method 600 may include processing operations such as those shown in FIG. 4C in some examples.

At 602, an injection tool can be provisioned for creating a panel with living hinge(s) as described above. For example, this can include installing a mold for the panel with multiple areas of differing thickness and/or adjusting any processing settings that may be required for the remaining portions of method 600. The mold can be configured to define a shape of the panel (e.g., panel 300) by its negative space such that at least one first section of the panel has a first thickness (e.g., section 400) and at least one second section formed integrally with the at least one first section has a second thickness that is thinner than the first thickness (e.g., section 410). When the panel is completed, the at least one second section can form at least one living hinge (e.g., living hinge 310) within the panel.

At 604, the injection tool can be operated to inject material into the mold using any known or novel injection molding techniques in order to create a panel as defined by the negative space of the mold.

At 606, the material that has been injected into the mold can be allowed to set, thereby forming the panel.

At 608, the panel with the living hinge may be removed from the mold. In some examples, the panel may be trimmed after the material within the mold has set, either before or after removal from the mold.

At 610, the structure formed by processing at 602-608 may be installed, for example within a vehicle. Specifically, the panel may be folded along its living hinge(s) and secured in a desired location in folded position using any known or novel mounting techniques.

Processes 500 and 600 are shown and described separately for ease of explanation, but it should be understood that the processes may be performed in combination to provide panels having both living hinges and integrally molded features. For example, a panel with a living hinge may be formed by performing process 600 as shown in FIG. 6, and then this panel may be used in performing process 500 as shown in FIG. 5, resulting in a panel with a living hinge and an integrally molded feature. Likewise, structures produced by process 500 and/or process 600 may be subjected to other processing outside the scope of the present disclosure, as desired.

### EXAMPLES

Some examples of the present disclosure include the following:

Example 1. A structure comprising: a panel having a first side and a second side and comprising a permeable matrix; and at least one feature coupled to the panel by being injection molded from the second side and passing through the permeable matrix to the first side.

Example 2. The structure of example 1, wherein the panel further comprises: at least one first section having a first thickness; and at least one second section formed integrally with the at least one first section and having a second thickness that is thinner than the first thickness, the at least one second section forming at least one living hinge within the panel.

Example 3. The structure of example 2, wherein the panel is installed within an assembly with the at least one living hinge in a folded position.

Example 4. The structure of example 2, wherein the at least one first section and the at least one second section are respective sections of a contiguously-formed molded matrix.

Example 5. The structure of any one of examples 1-4, wherein the at least one feature passes through the permeable matrix at an uncut location within the permeable matrix.

Example 6. The structure of any one of examples 1-5, wherein the permeable matrix comprises an injection-molded composite material.

Example 7. The structure of any one of examples 1-6, wherein the at least one feature comprises a thermoplastic material.

Example 8. A structure comprising: a single-piece molded matrix comprising: at least one first section having a first thickness; and at least one second section formed integrally with the at least one first section and having a second thickness that is thinner than the first thickness, the at least one second section forming at least one living hinge within the single-piece molded matrix.

Example 9. The structure of example 8, wherein the at least one first section is permeable and has a first side and a second side, the structure further comprising at least one feature coupled to the at least one first section by being injection molded from the second side and passing through to the first side.

Example 10. The structure of example 8 or example 9, wherein the at least one second section is defined by a shape of a mold in which the single-piece molded matrix is formed.

Example 11. The structure of any one of examples 8-10, wherein the single-piece molded matrix is installed within an assembly with the at least one living hinge in a folded position.

Example 12. The structure of any one of examples 8-11, wherein the single-piece molded matrix comprises an injection-molded composite material.

Example 13. A method comprising: loading a panel having a first side and a second side and comprising a permeable matrix into an injection tool; providing a mold facing the first side of the panel, the mold defining at least one feature to be formed by material injected into the mold; injecting, by the injection tool, the material through the permeable matrix so that the material passes through the permeable matrix from the second side to the first side by the injecting; and setting the material that has been injected through the permeable matrix within the mold to form the at least one feature and couple the at least one feature to the panel.

Example 14. The method of example 13, wherein the injecting forces the material through an uncut portion of the permeable matrix through injection pressure.

Example 15. The method of example 13 or example 14, further comprising heating the material prior to the injecting, wherein the setting comprises cooling the material within the mold.

Example 16. The method of any one of examples 13-15, further comprising trimming at least one of the at least one feature and the permeable matrix after the setting.

Example 17. The method of any one of examples 13-16, further comprising forming the panel, the forming comprising: filling a mold with a composite material, wherein the mold defines a shape of the panel such that: at least one first section of the panel has a first thickness, and at least one second section formed integrally with the at least one first section has a second thickness that is thinner than the first thickness, the at least one second section forming at least one living hinge within the panel; and setting the composite material in the mold to form the panel.

Example 18. The method of example 17, further comprising installing the panel into an assembly after the setting, the installing comprising folding the at least one living hinge and securing the panel to the assembly with the at least one living hinge in a folded position.

Example 19. The method of any one of examples 13-18, wherein the permeable matrix comprises an injection-molded composite material.

Example 20. The method of any one of examples 13-19, wherein the material comprises a thermoplastic material.

While various examples have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative examples. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A structure comprising:
a panel having a first side and a second side and comprising a permeable matrix; and
at least one feature coupled to the panel by being injection molded from the second side and passing through the permeable matrix to the first side.

2. The structure of claim 1, wherein the panel further comprises:
at least one first section having a first thickness; and
at least one second section formed integrally with the at least one first section and having a second thickness that is thinner than the first thickness, the at least one second section forming at least one living hinge within the panel.

3. The structure of claim 2, wherein the panel is installed within an assembly with the at least one living hinge in a folded position.

4. The structure of claim 2, wherein the at least one first section and the at least one second section are respective sections of a contiguously-formed molded matrix.

5. The structure of claim 1, wherein the at least one feature passes through the permeable matrix at an uncut location within the permeable matrix.

6. The structure of claim 1, wherein the permeable matrix comprises an injection-molded composite material.

7. The structure of claim 1, wherein the at least one feature comprises a thermoplastic material.

8. A structure comprising:
a single-piece molded matrix comprising:
at least one first section having a first thickness; and
at least one second section formed integrally with the at least one first section and having a second thickness that is thinner than the first thickness, the at least one second section forming at least one living hinge within the single-piece molded matrix.

9. The structure of claim 8, wherein the at least one first section is permeable and has a first side and a second side, the structure further comprising at least one feature coupled to the at least one first section by being injection molded from the second side and passing through to the first side.

10. The structure of claim 8, wherein the at least one second section is defined by a shape of a mold in which the single-piece molded matrix is formed.

11. The structure of claim 8, wherein the single-piece molded matrix is installed within an assembly with the at least one living hinge in a folded position.

12. The structure of claim 8, wherein the single-piece molded matrix comprises an injection-molded composite material.

13. A method comprising:
loading a panel having a first side and a second side and comprising a permeable matrix into an injection tool;
providing a mold facing the first side of the panel, the mold defining at least one feature to be formed by material injected into the mold;
injecting, by the injection tool, the material through the permeable matrix so that the material passes through the permeable matrix from the second side to the first side by the injecting; and
setting the material that has been injected through the permeable matrix within the mold to form the at least one feature and couple the at least one feature to the panel.

14. The method of claim 13, wherein the injecting forces the material through an uncut portion of the permeable matrix through injection pressure.

15. The method of claim 13, further comprising heating the material prior to the injecting, wherein the setting comprises cooling the material within the mold.

16. The method of claim 13, further comprising trimming at least one of the at least one feature and the permeable matrix after the setting.

17. The method of claim 13, further comprising forming the panel, the forming comprising:
filling a mold with a composite material, wherein the mold defines a shape of the panel such that:
at least one first section of the panel has a first thickness, and
at least one second section formed integrally with the at least one first section has a second thickness that is thinner than the first thickness, the at least one second section forming at least one living hinge within the panel; and
setting the composite material in the mold to form the panel.

18. The method of claim 17, further comprising installing the panel into an assembly after the setting, the installing comprising folding the at least one living hinge and securing the panel to the assembly with the at least one living hinge in a folded position.

19. The method of claim 13, wherein the permeable matrix comprises an injection-molded composite material.

20. The method of claim 13, wherein the material comprises a thermoplastic material.
